(19) United States
(12) Patent Application Publication
(10) Pub. No.: US 2019/0120348 A1
(43) Pub. Date: Apr. 25, 2019

(54) OSCILLATION DRIVE TOOL

(71) Applicant: Mark Turner, Arlington, TX (US)

(72) Inventor: Mark Turner, Arlington, TX (US)

(21) Appl. No.: 16/171,187

(22) Filed: Oct. 25, 2018

Related U.S. Application Data
(60) Provisional application No. 62/576,758, filed on Oct. 25, 2017.

(51) Int. Cl. F16H 25/16; B25F 5/02; B23B 51/04

(52) U.S. Cl. CPC F16H 25/16; B23B 51/0406; B25F 5/02

(57) ABSTRACT

An oscillation drive tool includes an input drive element removably couplable to a drive device. The input drive element is configured to receive a rotational input from the drive device. The tool also includes an output drive element removably couplable to a working device. The tool further includes a drive cam coupled to the input drive element and a cam plate configured to provide an oscillating rotational movement to the output drive element in response to receiving a rotational input from the drive cam.

### BACKGROUND

There are a variety of tools that are designed to provide oscillating motion. These tools usually have a motor that provides an oscillating output (e.g., via an oscillating shaft). A variety of types of accessories may then be attached to the tool, such as cutting blades, sanding discs, grinding wheels, etc.

### BRIEF SUMMARY

According to one aspect of the present disclosure, an oscillation drive tool includes an input drive element removably couplable to a drive device. The input drive element is configured to receive a rotational input from the drive device. The tool also includes an output drive element removably couplable to a working device. The tool further includes a drive cam coupled to the input drive element and a cam plate configured to provide an oscillating rotational movement to the output drive element in response to receiving a rotational input from the drive cam.

According to another embodiment of the present disclosure, an oscillation drive tool includes a housing enclosing a drive cam and a cam plate where the cam plate has a variable profile for engaging the drive cam. An input drive element extends from a first side of the housing and is coupled to the drive cam. An output drive element extends from a second side of the housing opposite the first side and is coupled to the cam plate. Responsive to a rotational input received by the input drive element, the output drive element provides oscillating rotational movement.

According to another embodiment of the present disclosure, an oscillation drive tool includes a housing enclosing a drive cam and a cam plate where the cam plate has a variable profile opening for engaging the drive cam therein. An input drive element extends from the housing and is coupled to the drive cam. An output drive element extends from the housing and is coupled to the cam plate. The input drive element and the output drive element are axially parallel and offset from each other. Responsive to a rotational input received by the input drive element, the output drive element provides oscillating rotational movement.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating a top, front perspective view of an oscillation drive tool according to the present disclosure;

FIG. 2 is a diagram illustrating a front view of the oscillation drive tool of FIG. 1 according to the present disclosure;

FIG. 3 is a diagram illustrating a top view of the oscillation drive tool of FIG. 1 according to the present disclosure from the direction indicated by the line 3-3 of FIG. 2;

FIG. 4 is a diagram illustrating a side view of the oscillation drive tool of FIG. 1 according to the present disclosure from the direction indicated by the line 4-4 of FIG. 2;

FIG. 5 is a diagram illustrating a rear view of the oscillation drive tool of FIG. 1 according to the present disclosure;

FIG. 6 is a diagram illustrating a top, rear perspective view of the oscillation drive tool of FIG. 1 according to the present disclosure;

FIG. 7 is a diagram illustrating a top, front perspective view of the oscillation drive tool of FIG. 1 according to the present disclosure with a housing cover plate removed;

FIG. 8 is a diagram illustrating a front view of the oscillation drive tool depicted in FIG. 7 according to the present disclosure;

FIG. 9 is a diagram illustrating the positioning of a hole saw that may be secured to the oscillation drive tool of FIG. 1 according to the present disclosure;

FIG. 10 is a diagram illustrating a front, perspective, exploded assembly view of the oscillation drive tool of FIG. 1 according to the present disclosure; and

FIG. 11 is a diagram illustrating another front, perspective, exploded assembly view of the oscillation drive tool of FIG. 1 according to the present disclosure.

### DETAILED DESCRIPTION

Embodiments of the present disclosure provide a tool/device that is couplable to working devices or accessories that function or are operable using oscillating rotational movement while using any type of rotational drive or input device. According to one embodiment, an oscillation drive tool includes an input drive element removably couplable to a drive device. The input drive element is configured to receive a rotational input from the drive device. The tool also includes an output drive element removably couplable to a working device. The tool further includes a drive cam coupled to the input drive element and a cam plate configured to provide an oscillating rotational movement to the output drive element in response to receiving a rotational input from the drive cam. In some embodiments, the oscillating drive device is a passive intermediary and/or converter device located between a drive device providing a rotational drive input (e.g., a continuous and/or non-continuous rotational clockwise or counterclockwise input, such as a drill) and a working device/attachment/accessory (e.g., a saw, cutting blade, sanding disc, grinding wheel, etc.) that converts that rotational input into an oscillating rotational movement (e.g., reciprocating movement along a circular arc). For example, in one exemplary application, a drill may be attached to an input of the oscillating drive device of the present disclosure and a hole saw may be coupled to the output side of the oscillating drive device. The oscillating drive device receives the rotational input from the drill and converts the rotational input into an oscillating output such that the oscillating drive device vibrates the hole saw back and forth in a narrow arc (e.g., approximately 3°-4°) and causes the hole saw to create an opening in a structure.

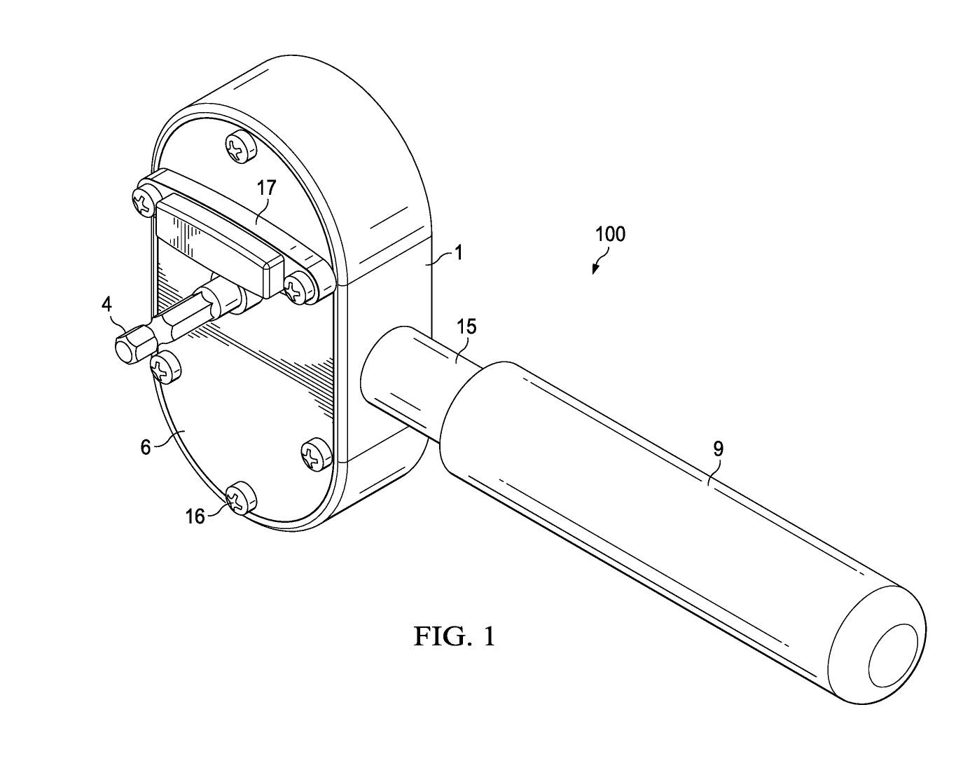

With reference now to the Figures and in particular with reference to FIGS. 1-11, an oscillation drive tool 100 according to the present disclosure is illustrated. The oscillation drive tool 100 is configured to receive a rotational drive input (e.g., a continuous rotational drive input (e.g., via a drill)) and produce an oscillating rotational output (e.g., approximately 3°-5° movement in each direction (e.g., clockwise and counter-clockwise) relative to a vertical axis). The output of the tool 100 may be coupled to another device (e.g., a hole saw) to thereby produce corresponding rotational oscillating movement of the hole saw relative to some structure. For example, embodiments of oscillation drive tool 100 the present disclosure translate and/or convert a continuously rotating input (e.g., via a drill) to an oscillating rotational output (e.g., reciprocating movement along a circular arc). Embodiments of the present disclosure provide an oscillation drive tool 100 that is an independent and/or intermediary device attachable to various types of rotational drive input devices (e.g., a drill or other type of device) and attachable to various types of working devices (e.g., a hole saw, sanding device, etc.). that may be operated based on oscillating rotational movement.

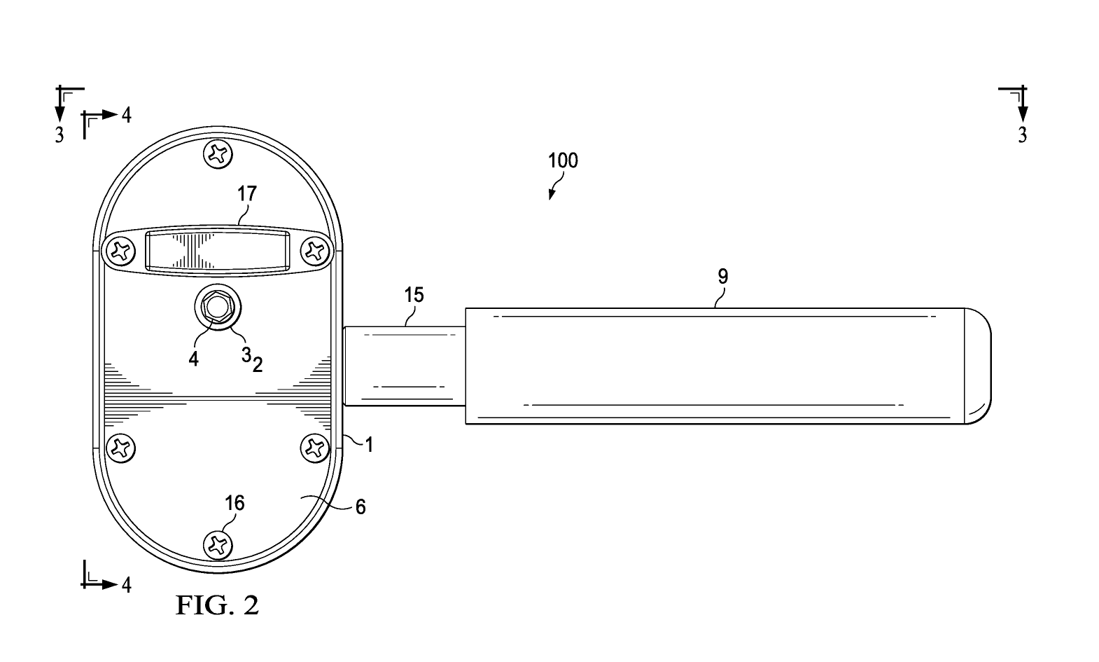

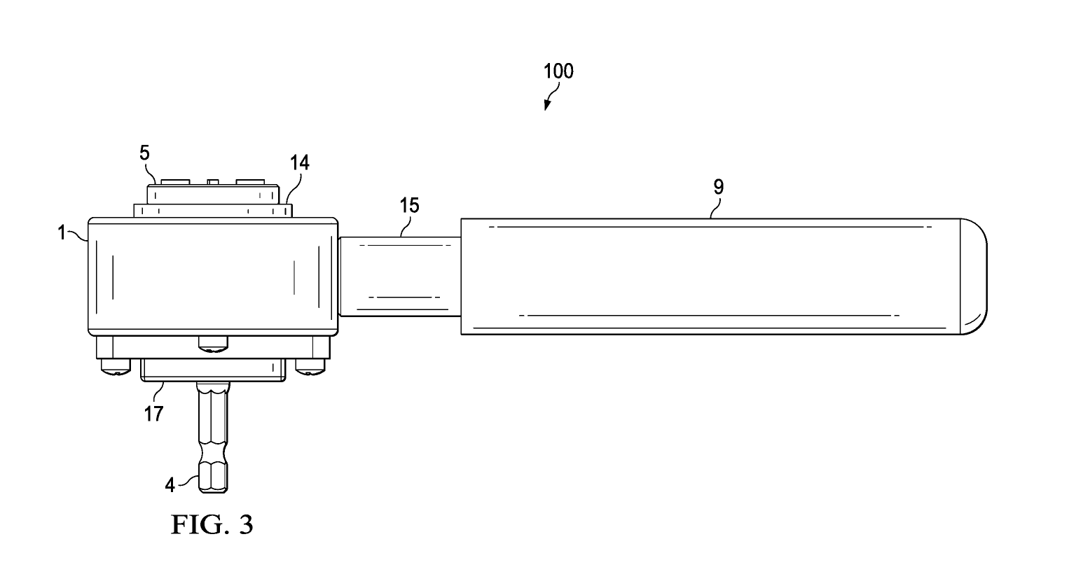

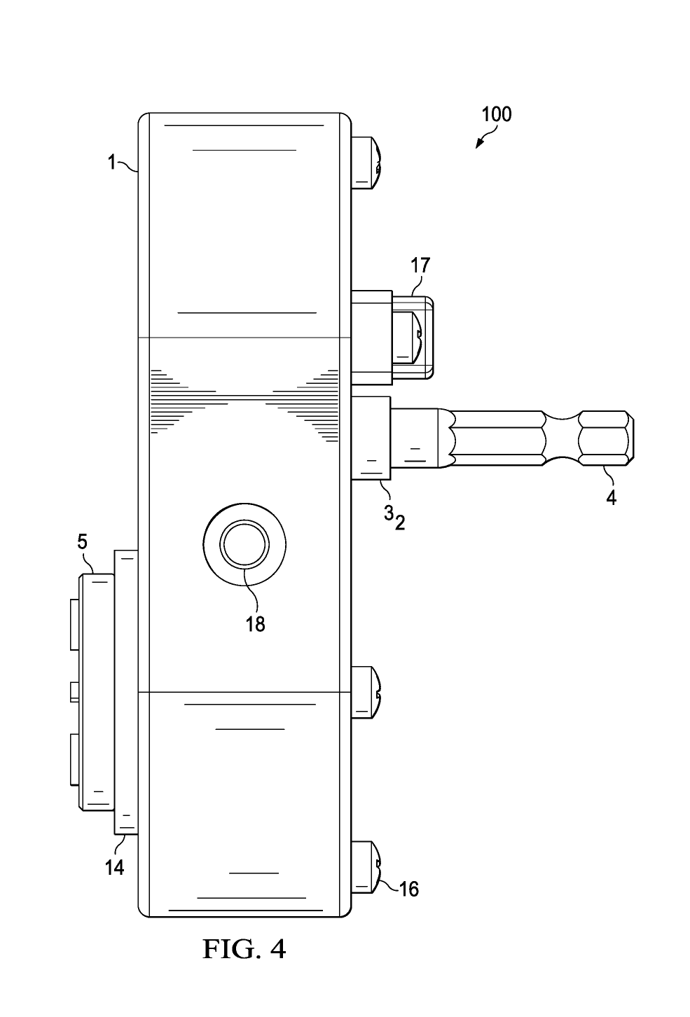

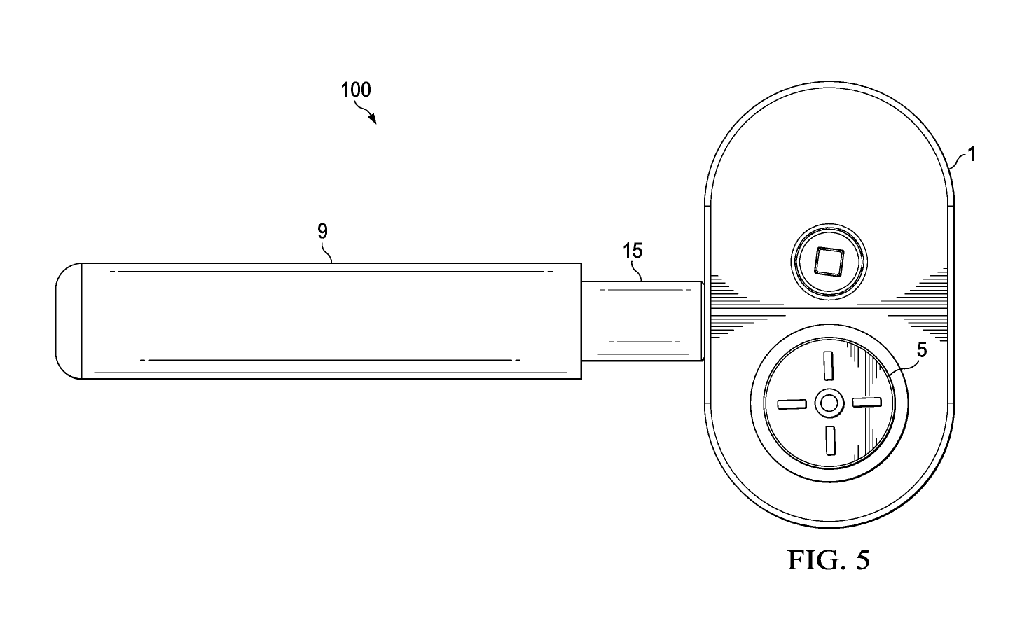

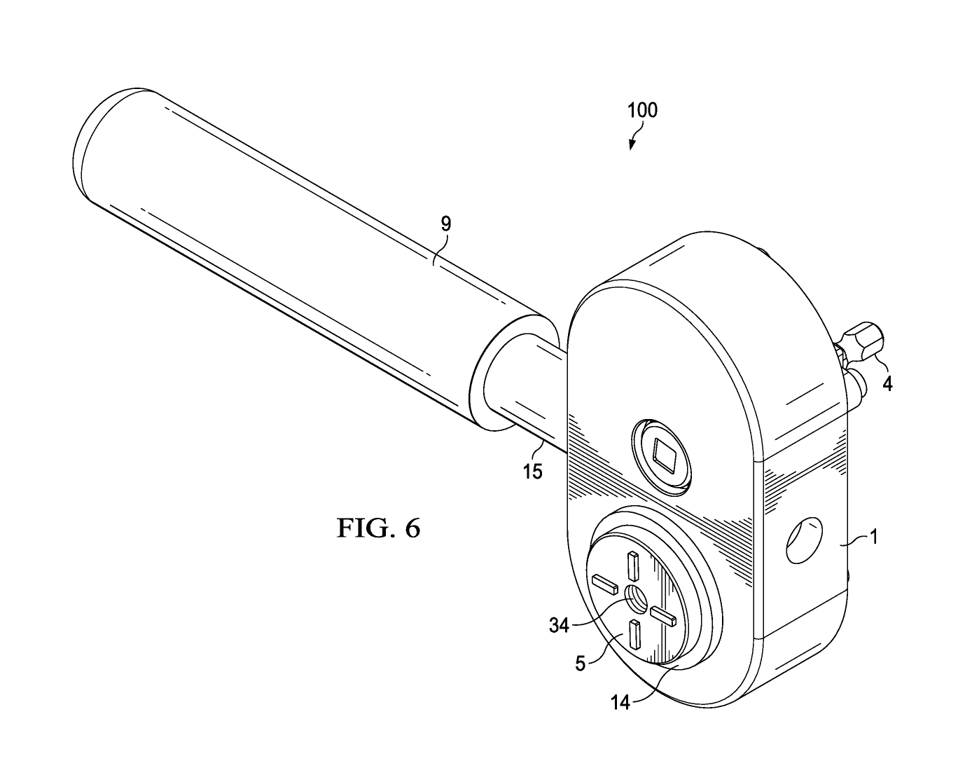

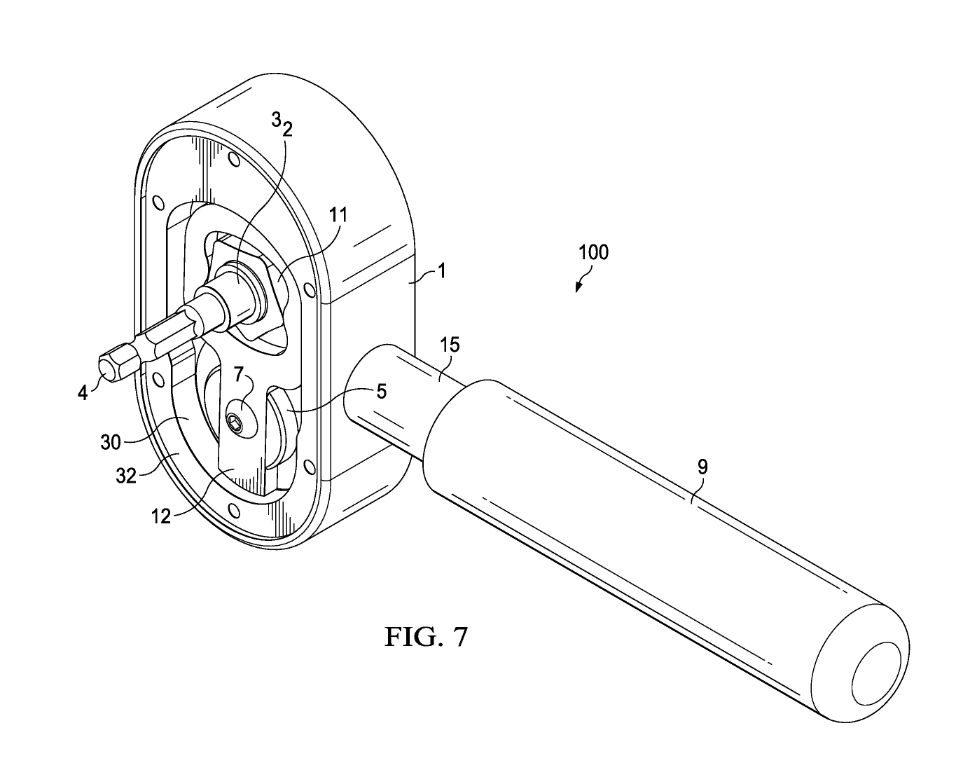

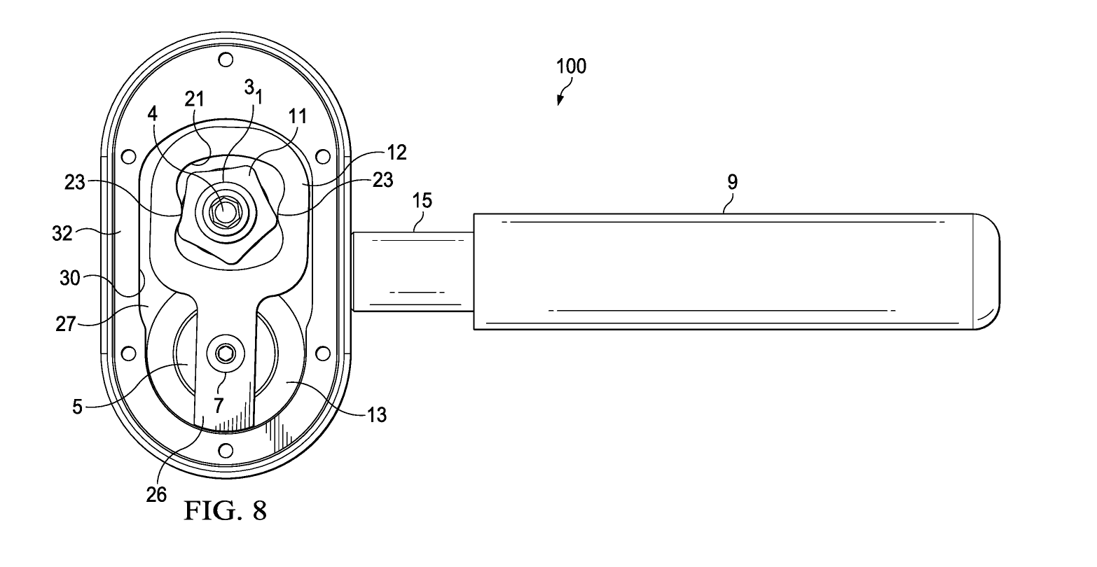

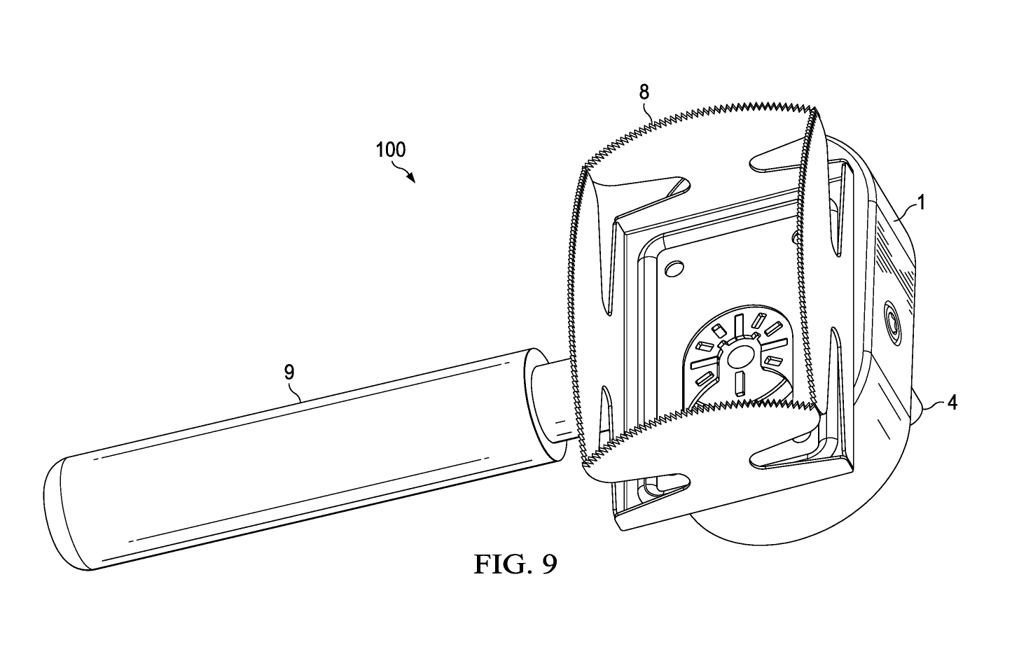

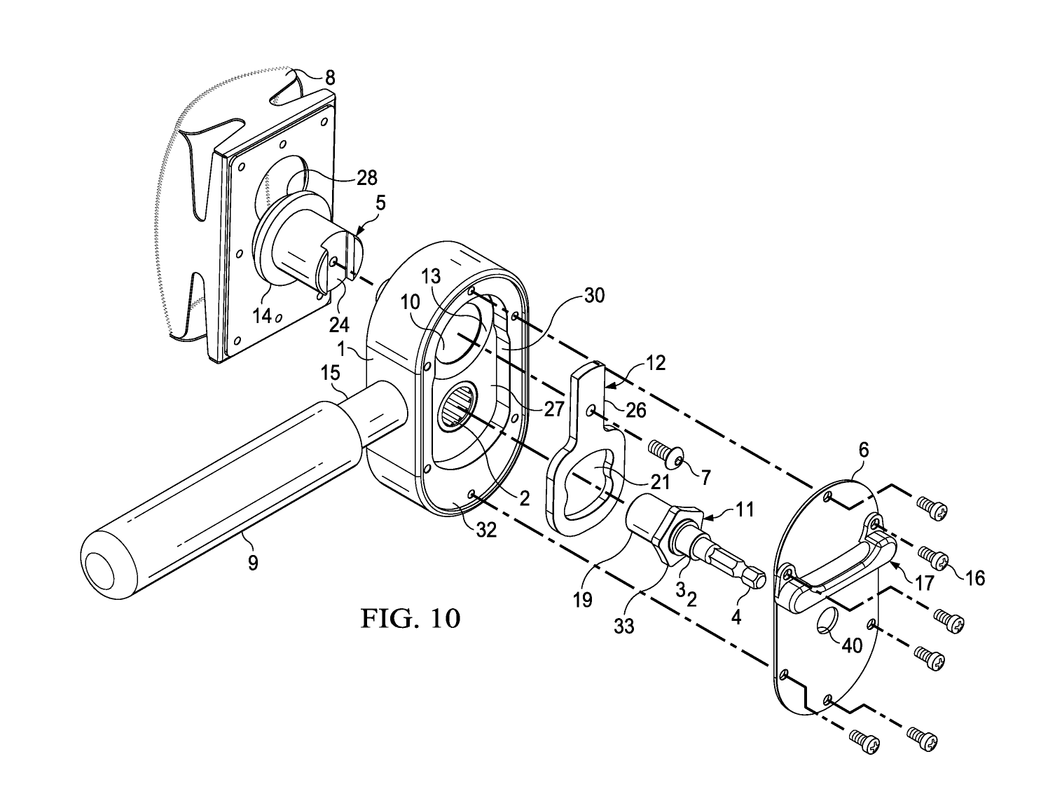

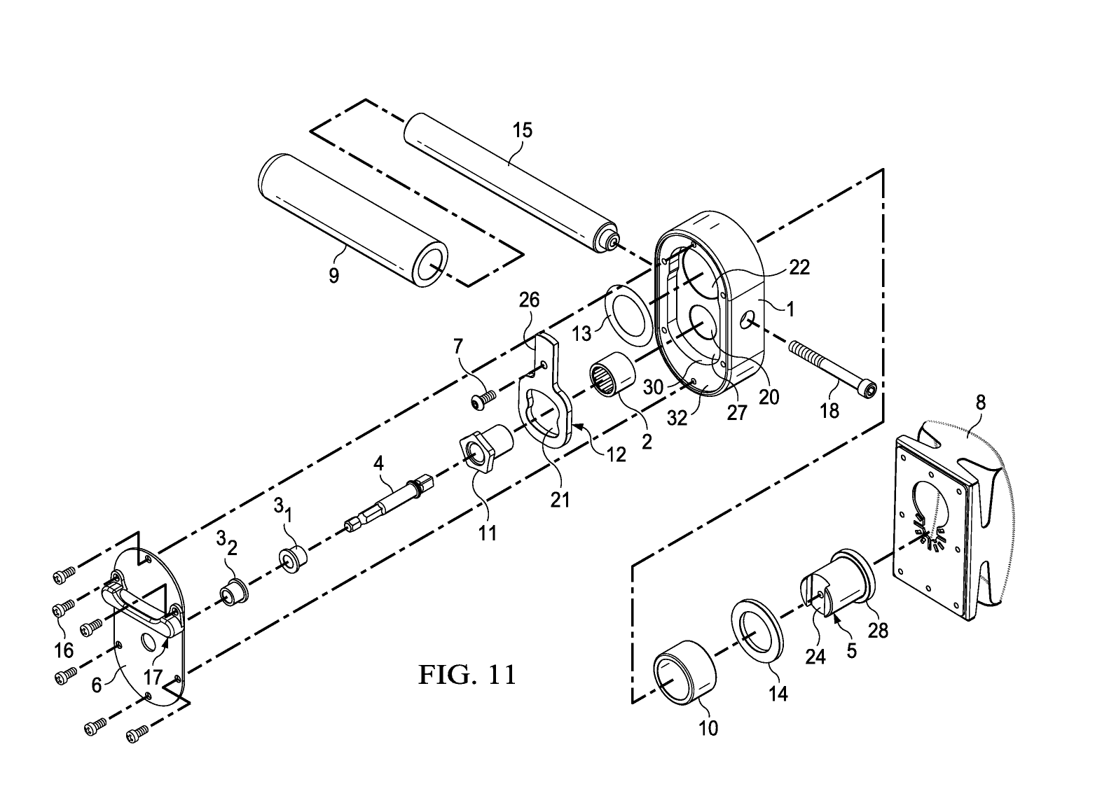

FIG. 1 is a diagram illustrating a top, front perspective view of an oscillation drive tool according to the present disclosure; FIG. 2 is a diagram illustrating a front view of the oscillation drive tool of FIG. 1 according to the present disclosure; FIG. 3 is a diagram illustrating a top view of the oscillation drive tool of FIG. 1 according to the present disclosure from the direction indicated by the line 3-3 of FIG. 2; FIG. 4 is a diagram illustrating a side view of the oscillation drive tool of FIG. 1 according to the present disclosure from the direction indicated by the line 4-4 of FIG. 2; FIG. 5 is a diagram illustrating a rear view of the oscillation drive tool of FIG. 1 according to the present disclosure; FIG. 6 is a diagram illustrating a top, rear perspective view of the oscillation drive tool of FIG. 1 according to the present disclosure; FIG. 7 is a diagram illustrating a top, front perspective view of the oscillation drive tool of FIG. 1 according to the present disclosure with a housing cover plate removed; FIG. 8 is a diagram illustrating a front view of the oscillation drive tool depicted in FIG. 7 according to the present disclosure; FIG. 9 is a diagram illustrating the positioning of a hole saw that may be secured to the oscillation drive tool of FIG. 1 according to the present disclosure; FIG. 10 is a diagram illustrating a front, perspective, exploded assembly view of the oscillation drive tool of FIG. 1 according to the present disclosure; and FIG. 11 is a diagram illustrating another front, perspective, exploded assembly view of the oscillation drive tool of FIG. 1 according to the present disclosure.

In the illustrated embodiment, the drive tool 100 includes a drive housing 1 having an opening 20 for supporting therein a needle bearing 2. A drive cam 11 has a cylindrical lower portion 19 for slideable insertion into and rotational movement relative to the needle bearing 2. The upper portion of the drive cam 11 (opposite the end of the cylindrical portion 19) has a cam (or a cam-configured portion) 33 for causing movement of a follower or cam drive plate 12 in response to a rotational input to the drive cam 11. For example, in the illustrated embodiment, tool 100 includes an input drive shaft 4. In the illustrated embodiment, input drive shaft 4 is a ¼ hex-to-¼ square drive shaft having the square end thereof coupled to the cam drive 11 via a flange bearing 31 (e.g., secured into a square opening formed in the cam drive 11). The hex end of the drive shaft 4 is couplable to a rotational drive device (e.g., a drill) that provides a rotational input to drive shaft 4 and cam drive 11. It should be understood that other sizes, dimensions, and/or configurations of input drive shaft 4 may be used.

In the illustrated figures, the cam portion 33 of drive cam 11 is configured having a generally pentagonal lobe profile extending outwardly therefrom providing a 5:1 displacement or movement ratio of the cam plate drive 12 per rotation of the drive cam 11. However, it should be understood that other profiles/ratios may be used. In this embodiment, the cam portion 33 of drive cam 11 is positioned within an opening 21 in the cam drive plate 12 where the internal profile of the opening 21 has oppositely disposed, internally facing, lobes 23 keyed to the lobes/heels of the drive cam 11 (e.g., a variable profile). For example, in this embodiment, the internally facing lobes 23 of the opening 21 are in contact with the cam portion 33 of drive cam 11 to restrain movement of the cam drive plate 12 (e.g., while one internal lobe 23 of opening 21 is in contact with a lobe of drive cam 11, the opposite lobe 23 of opening 21 is in contact with a heel of the drive cam, the internal lobes 23 of opening 21 substantially remaining in contact with the surface of drive cam 11 throughout its rotation to provide smooth oscillating movement of the cam drive plate 12). Thus, cam drive plate 12 rotationally oscillates/pivots in a plane perpendicular to the axis of rotational input/output. Further, in the illustrated embodiment, the cam drive plate 12 has lobes 23 on opposite sides of drive cam 11 (e.g., at least two different sides of drive cam 11), thereby enabling drive cam 11 to provide an oscillation force in two different directions against cam plate drive 12 resulting from the rotation of drive cam 11. Accordingly, embodiments of the present disclosure provide an oscillation force in multiple directions, thereby resulting in less rotational power or force required from any attached rotational drive device (e.g., less force needed to return the cam drive plate 12 to a previous location/direction). Additionally, embodiments of the present invention provide an oscillation speed greater than the rotational speed of a rotational drive input.

In the illustrated embodiment, drive housing 1 has another opening 22 adjacent to and spaced apart from the opening 20. The opening 22 supports therein a needle bearing 10. Tool 100 also includes an output drive shaft 5 slideably inserted into and rotatable relative to the needle bearing 10. The output drive shaft 5 extends outwardly from housing 1 in a direction opposite than the input drive shaft 4. The output drive shaft 5 has a recess 24 formed in one end thereof for receiving therein an extender arm 26 of the cam drive plate 12 (e.g., a rectangular-shaped recess extending across a middle portion of the end of drive shaft 5). The cam drive plate 12 is coupled to output drive shaft 5 via a fastener 7 extending through extender arm 26 and into output drive shaft 5, thereby enabling cam drive plate 12 to pivot relative to drive cam 11 relative to the fastener 7 location.

In the illustrated embodiment, a shim washer 13 is placed over output drive shaft 5 and is positioned at least partially between a portion of cam drive plate 12 and a recessed surface 27 of housing 1, thereby providing a slight gap between cam drive plate 12 and recessed surface 27 (i.e., ensuring that the freestanding portion of cam drive plate 12 is slightly spaced apart from surface 27 to enable free pivotal movement thereof relative to surface 27). In the illustrated embodiment, output drive shaft 5 is cylindrical and has a cylindrical flange 28 having a larger diameter than a body of the shaft 5 where the flange 28 is at an end of shaft 5 opposite the end having cam drive plate 12 coupled thereto. The end of shaft 5 with flange 28 also has an internally threaded opening 34 for receiving a fastener therein for securing an output receiving or working device 8 (e.g., a hole saw) thereto. A thrust washer 14 is disposed between the flange 28 and a corresponding outer surface of housing 1.

Housing 1 includes an inner recessed area 30 for receiving therein drive cam 11 and cam drive plate 12 and an outer recessed area 32 extending about a perimeter of housing 1. A housing cover plate 6 is secured to housing 1 within outer recessed area 32 via fasteners 16, thereby securing drive cam 11 and cam drive plate 12 within housing 1. Cover plate 6 also incudes a flange bearing 32 disposed in an opening 40 thereof to receive input drive shaft 4 extending therethrough.

In the illustrated embodiment, tool 100 also includes a handle 15 securable to housing 1 via a fastener 18 (e.g., extending through a centrally disposed opening in housing 1 and into a threaded opening in handle 15). Handle 15 may be reversibly located relative to housing 1 to the opposite side of housing 1 (e.g., by reversing the locations/positions of handle 15 and fastener 18). A grip 9 may be placed over handle 15 (e.g., a rubber or plastic molded element to provide a secure gripping surface on handle 15).

Tool 100 may also include a level assembly 17 secured to cover plate 6 to assist the positioning of tool 100 (or device 18) in a particular orientation relative to some structure (e.g., for maintaining a horizontal orientation). Level assembly 17 may include a glass/liquid level 19 positioned within a holder or housing attached to cover plate 6.

Thus, in operation, a rotational drive device (e.g., a drill) may be coupled to input drive shaft 4 to provide a continuous and/or non-continuous rotational input to tool 100 via the input drive shaft 4. A tool or working device 8 (e.g., a hole saw) operational based on an oscillating input (e.g., a circular oscillating movement of some desired number of degrees) may be coupled to the output drive shaft 5. In this manner, the rotational input and the oscillating output are essentially in the same direction (e.g., in the illustrated embodiment, parallel to each other but not axially aligned) while the rotational input is received on one side of tool 100 and the oscillating output is provided via the other, opposite side of the tool 100. In operation, the rotational input received via input drive shaft 4 is communicated to drive cam 11. Rotation of drive cam 11 causes oscillating pivotal movement of cam drive plate 12 about the axis of the output drive shaft 5 (e.g., the cam drive plate 12 is coupled to output drive shaft 5 via fastener 7 positioned on the axis of rotation of output drive shaft 5). Thus, for example, a hole saw may be attached to output drive shaft 5 and a drill may be attached to input drive shaft 4. A user may position the hole saw against a surface to be cut using handle 15 and/or the drill (e.g., a user grasping the handle 15 with one hand while holding the drill with the other hand). The level 19 may be used to visually indicate to the user the relative position and/or orientation of the tool 100 (and corresponding hole saw). The user may then activate the drill to thereby cause oscillating rotational movement of the hole saw relative to the surface to be cut. As indicated above, the handle 15 may be located on either side of tool 100 to accommodate a desired hand of the user to hold the tool 100.

Thus, embodiments of the present invention enable the generation of an alternating and/or oscillating circular movement using any type of rotational input device to be imparted to a desired accessory tool. For example, embodiments of the present invention enable the conversion of a continuous rotational input (e.g., rotating in a particular direction (e.g., clockwise or counterclockwise) over and through a 360 degree rotation (or part thereof)) to an oscillating and/or reciprocal rotational motion. Accordingly, the oscillation drive device of the present disclosure enables the use of conventional rotational drive devices (e.g., a drill) to be used in connection with accessory tool/devices operational with a reciprocating rotational movement to be used without the need to purchase a specialized oscillating drive motor.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An oscillation drive tool, comprising:
an input drive element removably couplable to a drive device, the input drive element configured to receive a rotational input from the drive device;
an output drive element removably couplable to a working device;
a drive cam coupled to the input drive element; and
a cam plate configured to provide an oscillating rotational movement to the output drive element in response to receiving a rotational input from the drive cam.

2. The oscillation drive tool of claim 1, wherein the cam plate has an opening having a variable profile for receiving the drive cam therein.

3. The oscillation drive tool of claim 1, wherein the cam plate has an opening having internally facing lobes that engage the drive cam.

4. The oscillation drive tool of claim 1, wherein:
the cam plate has an opening with an internally facing lobe profile; and
the drive cam has externally facing lobes that engage the internally facing lobe profile of the cam plate.

5. The oscillation drive tool of claim 1, wherein the cam plate rotationally oscillates in a plane perpendicular to an axis of the rotational input.

6. The oscillation drive tool of claim 1, wherein an axis of the rotational input is parallel to and offset from an axis of the oscillating rotational movement of the output drive element.

7. The oscillation drive tool of claim 1, wherein the drive cam and the cam plate are configured to provide a 5:1 oscillating movement ratio to the output drive element per rotation of the drive cam.

8. An oscillation drive tool, comprising:
a housing enclosing a drive cam and a cam plate, the cam plate having a variable profile for engaging the drive cam;
an input drive element extending from a first side of the housing and coupled to the drive cam; and
an output drive element extending from a second side of the housing opposite the first side, the output drive element coupled to the cam plate; and
wherein responsive to a rotational input received by the input drive element, the output drive element provides oscillating rotational movement.

9. The oscillation drive tool of claim 8, wherein the cam plate rotationally oscillates in a plane perpendicular to an axis of the rotational input.

10. The oscillation drive tool of claim 8, wherein an axis of the rotational input is parallel to and offset from an axis of the oscillating rotational movement of the output drive element.

11. The oscillation drive tool of claim 8, wherein the cam plate has an opening having the variable profile for receiving engagement of the drive cam therein.

12. The oscillation drive tool of claim 8, wherein:
the cam plate has an opening with an internally facing lobes; and
the drive cam has externally facing lobes that engage the internally facing lobes of the cam plate.

13. The oscillation drive tool of claim 8, further comprising a handle coupled to the housing.

14. The oscillation drive tool of claim 8, further comprising a level assembly coupled to the housing.

15. An oscillation drive tool, comprising:
a housing enclosing a drive cam and a cam plate, the cam plate having a variable profile opening for engaging the drive cam therein;
an input drive element extending from the housing and coupled to the drive cam; and
an output drive element extending from the housing and coupled to the cam plate, the input drive element and the output drive element axially parallel and offset from each other; and
wherein responsive to a rotational input received by the input drive element, the output drive element provides oscillating rotational movement.

16. The oscillation drive tool of claim 15, wherein the cam plate rotationally oscillates in a plane perpendicular to an axis of the rotational input.

17. The oscillation drive tool of claim 15, wherein the drive cam has externally facing lobes that engage the variable profile of the cam plate.

18. The oscillation drive tool of claim 15, wherein the drive cam and the cam plate are configured to provide a 5:1 oscillating movement ratio to the output drive element per rotation of the drive cam.

19. The oscillation drive tool of claim 15, further comprising a handle coupled to the housing.

20. The oscillation drive tool of claim 15, further comprising a level assembly coupled to a side of the housing having the input drive element.
